(19) United States
(12) Patent Application Publication
(10) Pub. No.: US 2021/0084955 A1
(43) Pub. Date: Mar. 25, 2021

(54) SWEETENER COMPOSITIONS FOR WEIGHT MANAGEMENT

(71) Applicant: SUCRAZIT LTD., Rosh-Ha'ayin (IL)

(72) Inventor: Lior LEVY, Tel Aviv (IL)

(21) Appl. No.: 16/954,754

(22) PCT Filed: Jan. 2, 2019
(86) PCT No.: PCT/IL2019/050005

§ 371 Date: Jun. 17, 2020

Related U.S. Application Data
(60) Provisional application No. 62/613,053, filed on Jan. 3, 2018.

(51) Int. Cl. A23L 33/105; A23L 27/30; A23L 33/00; A23L 2/60

(52) U.S. Cl. CPC A23L 33/105; A23L 27/36; A23V 2002/00; A23L 33/40; A23L 2/60; A23L 27/34

(57) ABSTRACT

Sweetener compositions are provided, particularly tabletop sweeteners, comprising ground Hoodia as a weight control agent in combination with the non-caloric sweetener rebaudioside A and erythritol.

### FIELD OF THE INVENTION

The present invention relates to sweetener compositions, particularly ready to use sweeteners, which are useful for weight management. The sweetener compositions comprise the non-caloric sweetener rebaudioside A, in combination with ground Hoodia plant.

### BACKGROUND OF THE INVENTION

Increasing public awareness of healthier lifestyle and weight management in recent years has led to growing interest in food products that aid in maintaining proper weight. In particular, there is great consumer interest in food products that can integrate easily into the regular diet, while being more healthy, for example containing fewer calories, less fat and the like.

The plant Stevia rebaudiana, commonly known as sweet leaf, sugarleaf, or simply “stevia”, is a source of natural glycosides which are used as sweeteners in various food products and sweetener compositions. In contrast to conventional sugars such as sucrose, glucose and fructose, the glycosides found in stevia leaves, termed ‘steviol glycosides’, are non-caloric and therefore considered a healthier alternative to the conventional sugars.

The main steviol glycosides extracted from stevia leaves are rebaudioside A and stevioside. Stevia leaves further contain smaller amounts of other steviol glycosides including rebaudiosides B to E, steviolbioside, rubusoside and dulcoside A. The steviol glycosides are high-intensity sweeteners, up to 200-300 times sweeter than sucrose. However, their taste profile is different from that of conventional sugars and they often exhibit bitter and liquorice aftertastes. Thus, commercial food products and sweetener compositions containing steviol glycosides typically further include ingredients that improve the overall taste, such as other low or non-caloric sweeteners.

In 2008, the U.S. Food and Drug Administration (FDA) confirmed a Generally Recognized as Safe (GRAS) status for high purity rebaudioside A (at least 95% pure) as a general-purpose sweetener in foods and beverages, and permitted its sale as a food ingredient. High purity rebaudioside A is also approved for sale as a food ingredient in the EU since 2011.

Hoodia is a genus of succulent plants from Southern Africa, traditionally used by the Khoi-San of South Africa and Namibia to suppress hunger and thirst while on long hunting trips. Extracts from plants of the Hoodia genus, in particular from the species Hoodia gordonii, have been shown to have an appetite suppression activity, and therefore such extracts received great attention as potential appetite suppressants for weight loss. H. gordonii extracts have been introduced into various food products and dietary supplements.

Recently, products based on ground aerial parts of Hoodia parviflora have been proposed, see for example Landor et al. (2015) J Med Food, 18(2): 250-258; and EFSA NDA Panel, Turck et al. (2017) EFSA Journal, (10):5002, 21 pp.

U.S. Pat. No. 7,815,960 discloses green tea extract formulations and methods for the preparation thereof. Various excipients may be added to the extract, either before or after drying, which are required in order to provide a formulation with desired properties. Examples of such excipients include, inter alia, stevia. According to additional embodiments, the green tea extract may be formulated into a green tea beverage, which may further comprise an herbal extract, inter alia, Hoodia.

U.S. Pat. No. 8,945,652 and WO 2007/061873 disclose functional sweetener compositions comprising at least one non-caloric or low-caloric natural and/or synthetic high potency sweetener, at least one sweet taste improving composition, and at least one functional ingredient, such as a weight management agent.

WO 2007/061795 discloses a natural high-potency sweetener (NHPS) composition with a more sugar-like temporal profile and/or flavor profile comprising at least one NHPS and/or at least one modified NHPS and at least one sweet taste improving composition selected from the group consisting of carbohydrates, polyols, amino acids, other sweet taste improving additives, and combinations thereof.

US 2008/0299258 entitled “Probiotic natural sweetener compositions with standardized levels of fiber and process to make” discloses prebiotic sweetener compositions that may contain stevia and provide higher levels of natural fiber as inulin when compared to other natural sweeteners in the market place.

WO 2016/038603 discloses a flavor modifying composition comprising a blend of a water-soluble filler comprising plant fibers; and at least one sucrose substitute of natural source, wherein said flavor modifying composition comprises at least 90% w/w of the filler, the amount being determined when said composition is in dry form; and said flavor modifying composition is water soluble. The flavor modifying composition is particularly effective in enhancing sweet taste and/or aroma of a product. Also disclosed are products comprising the flavor modifying composition.

US 2016/0113987 discloses compositions for preparing low dosage supplements in the form of a confectionery which are easy to swallow and have a desirable taste. The resulting compositions are suitable for delivering all-natural active ingredients to aid in alleviating a particular disease or promote overall well-being. Methods of forming the confectionery are also provided.

Food products that are integrated into the regular diet and promote weight reduction are highly desirable.

### SUMMARY OF THE INVENTION

The present invention provides according to some aspects sweetener compositions, particularly sweetener compositions which comprise an additional agent useful for weight reduction.

The sweetener compositions disclosed herein comprise Hoodia as a weight control agent in combination with the non-caloric sweetener rebaudioside A and erythritol. The present invention discloses for the first time a combination of ground Hoodia, rebaudioside A, and erythritol at particular proportions, which results in a sweetener composition that maintains the taste and feel of conventional sweeteners while promoting weight reduction. Advantageously, the sweetener compositions successfully incorporate ground Hoodia without adversely affecting the taste characteristics of the composition, its texture and the like. In addition, the sweetener compositions may be conveniently packaged as individual servings for use in beverages or other foodstuffs. Such ready-to-use sweetener compositions comprising particular proportions of ground Hoodia, rebaudioside A, and erythritol as disclosed herein have not been hitherto described. The sweetener compositions integrate well into a consumer's regular diet, with an added benefit of promoting weight reduction.

In particular, combinations of ground Hoodia, prepared from aerial parts of the plant, with highly pure rebaudioside A and erythritol at particular concentrations or proportions are disclosed, providing sweetener compositions effective in promoting weight loss.

According to one aspect, the present invention provides a sweetener composition in a powder form comprising:

0.5%-2% (w/w) ground Hoodia;

1.5%-4.5% (w/w) rebaudioside A, the rebaudioside A being at least 95% pure; and

95%-96.5% (w/w) erythritol.

In some embodiments, the Hoodia is Hoodia parviflora.

In some embodiments, the ground Hoodia is ground Hoodia prepared from the whole aerial parts of the plant.

In some embodiments, the rebaudioside A is at least 97% pure.

In some embodiments, the sweetener composition is consisting essentially of: 0.5%-2% (w/w) ground Hoodia; 1.5%-4.5% (w/w) rebaudioside A, the rebaudioside A being at least 95% pure; and 95%-96.5% (w/w) erythritol.

In some embodiments, the sweetener composition comprises: 0.5%-2% (w/w) ground Hoodia; 3% (w/w) rebaudioside A, the rebaudioside A being at least 95% pure; and 95%-96.5% (w/w) erythritol.

In some embodiments, the sweetener composition is consisting essentially of: 0.5%-2% (w/w) ground Hoodia; 3% (w/w) rebaudioside A, the rebaudioside A being at least 95% pure; and 95%-96.5% (w/w) erythritol.

In some embodiments, the sweetener composition consists of 2% (w/w) ground Hoodia, 3% (w/w) rebaudioside A and 95% (w/w) erythritol.

In additional embodiments, the sweetener composition consists of 0.5% (w/w) ground Hoodia, 3% (w/w) rebaudioside A and 96.5% (w/w) erythritol.

In some embodiments, the sweetener composition is packaged as an individual serving of 1 gr. total weight.

According to a further aspect, the present invention provides an individual serving of a sweetener composition comprising ground Hoodia, which provides an amount of Hoodia that is no more than 5-10% of the amount generally recognized as safe for daily consumption, and further comprising rebaudioside A, the rebaudioside A being at least 95% pure, and erythritol. In some embodiments, there is provided herein an individual serving of a sweetener composition consisting of: ground Hoodia, which provides an amount of Hoodia that is no more than 5-10% of the amount generally recognized as safe for daily consumption; rebaudioside A, the rebaudioside A being at least 95% pure; and erythritol.

According to a further aspect, the present invention provides a food product sweetened with the sweetener composition of the present invention.

In some particular embodiments, the food product is a beverage.

These and further aspects and features of the present invention will become apparent from the detailed description, examples and claims which follow.

### DETAILED DESCRIPTION OF THE INVENTION

The present invention provides according to some aspects sweetener compositions comprising Hoodia as a weight control agent in combination with the non-caloric sweetener rebaudioside A and erythritol.

One of the advantages of the sweetener compositions of the present invention is the ease of integrating it into the dietary routine. Thus, a sweetener composition according to the present invention is likely to be consumed more consistently compared to products such as dietary supplements comprising Hoodia as a weight control agent which are consumed separately, and consequently to provide a better outcome in terms of weight reduction.

According to some embodiments, the sweetener compositions of the present invention comprise 0.5%-2% (w/w) ground Hoodia; 3% (w/w) rebaudioside A, the rebaudioside A being at least 97% pure; and 95%-96.5% (w/w) erythritol.

The percentages of Hoodia specified herein are in accordance with the guidelines for safe daily intake of this material.

According to some embodiments, a sweetener composition comprising ground Hoodia packaged as an individual serving is provided, the sweetener composition provides no more than 5-10% of the amount of Hoodia approved for daily intake.

Hoodia is a genus of stem succulents with columnar-shaped, fleshy stems, arranged in a branching, shrub-like form. The stems are thorny with flowers near their top (during the flowering season). The term “Hoodia” as used herein encompasses any species of Hoodia. In some particular embodiments, the Hoodia species is Hoodia parviflora. In additional particular embodiments, the Hoodia species is Hoodia gordonii.

According to some embodiments, ground Hoodia in a powder form prepared from aerial parts of the plant is used for preparing the sweetener compositions of the present invention. The term “aerial parts” refers to parts of the plant that are above the soil. For preparing ground Hoodia for the sweetener compositions of the present invention, the plants are preferably harvested outside the flowering season and therefore “aerial parts” as used herein include stems and thorns, and do not include flowers. Briefly, aerial parts are excised from Hoodia plants, preferably of more than 3 years of age, sanitized, dried, cut and subsequently ground into a fine powder. The powder is typically a powder with particle size in the range of 400-700 micron, preferably in the range of 500-600. In some exemplary embodiments, the particle size in the powder is 600 micron. An exemplary process for preparing ground Hoodia is described in Example 1 below. According to these embodiments, the plant material is used with no exceptional extraction, purification, or concentration procedures, but only light processing such as cutting and grounding.

In some embodiments, the ground Hoodia is prepared from whole aerial parts of the plant. According to these embodiments, the ground Hoodia is prepared from the stems including the thorns. In other embodiments, the ground Hoodia is prepared from the stems without the thorns.

For preparing the sweetener compositions of the present invention, alternatives of ground Hoodia such as dried extracts may also be used. Hoodia extracts may be prepared from the stems of the plant, as known in the art.

The term “rebaudioside A” as used herein refers to the steviol glycoside identified by CAS Registry number 58543-16-1. The term encompasses the compound itself and also an extract from a Stevia plant (typically from the leaves) containing the compound, which is at least 95% pure, preferably at least 97% pure. The extract containing rebaudioside A according to the present invention has purity greater than 95%, meaning that it contains 95% or more rebaudioside A (by dry weight) and minor or even trace amounts of other steviol glycosides and/or other plant components such as cellulose and the like. Herein, the term “extract containing rebaudioside A with at least 95% purity” is used interchangeably with “rebaudioside A which is at least 95% pure”, “rebaudioside A with purity greater than 95%” and the like.

For preparing the sweetener compositions of the present invention, rebaudioside A which is at least 95% pure, preferably at least 97% pure, in a powder form is used.

In some embodiments, the rebaudioside A is at least 98% pure, at least 99% pure, or 100% pure, by dry weight. Each possibility represents a separate embodiment of the present invention.

Rebaudioside A is available in a purified form from various commercial sources.

Methods for purifying rebaudioside A are known in the art and described, for example, in U.S. Pat. Nos. 8,791,253 and 9,012,626. In brief, first, a crude extract of stevia leaves is prepared, typically by water extraction. Rebaudioside A is separated and purified via crystallization techniques.

For example, rebaudioside A may be crystallized in a single step from an aqueous organic solution comprising at least one organic solvent and water in an amount from about 10% to about 25% by weight, more particularly from about 15% to about 20% by weight. Suitable organic solvents include alcohols, acetone, and acetonitrile.

Purification of rebaudioside A may further include seeding the rebaudioside A solution at an appropriate temperature with high-purity crystals of rebaudioside A sufficient to promote crystallization of the rebaudioside A to form pure rebaudioside A.

Purification of rebaudioside A typically further includes separating and washing the purified rebaudioside A. The purified rebaudioside A may be separated from the aqueous organic solution by a variety of solid-liquid separation techniques that utilize centrifugal force. The process also typically includes washing the purified rebaudioside A using various aqueous organic solvents and mixtures thereof, and drying the purified rebaudioside A, partially or totally.

The purification process may be repeated or the purified rebaudioside A may be purified further using an alternative purification method, such as the column chromatography.

Purity of rebaudioside A can be measured, for example, by HPLC, as known in the art.

The term “erythritol” refers to the low-caloric sugar alcohol (polyol) identified by CAS Registry number 149-32-6. Erythritol is approved for use as a food additive throughout the world. Erythritol in a powder form is available commercially from various sources.

The sweetener compositions of the present invention are prepared, according to some embodiments, by mixing ground Hoodia, rebaudioside A and erythritol, each in a powder form, to obtain a blend in which the components are distributed evenly. According to some embodiments, the resulting blend is packaged as individual servings, each of 1 gr. total weight.

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

### EXAMPLES

### Example 1

### Tabletop Sweetener Composition in a Powder Form

A sweetener composition in a powder form containing ground Hoodia parviflora, rebaudioside A (97% pure) and erythritol was prepared. The sweetener composition contained 2% (w/w) ground H. parviflora, 3% (w/w) rebaudioside A and 95% (w/w) erythritol.

| Ingredient | Amounts | Supplier |
|---|---|---|
| Erythritol | 150 kg | ZHUCHENG DONGXIAO |
| | | BIOTECHNOLOGY CO. |
| | | LTD, CHINA |
| Rebaudioside A | 4.7 kg | NINGBO GREEN |
| (97% pure) | | HEALTH |
| | | PHARMACEUTICAL CO. |
| | | LTD, CHINA |
| H. parviflora | 3.1 kg | DESERT LABS, ISRAEL |
| powder* | | IN COOPERATION WITH |
| | | CHAM 2000 |
| | | INDUSTRIES, ISRAEL. |

The ingredients (all in a powder form) were dry blended to obtain a homogeneous blend. The resulting blend was packaged into 1 gram sachets.

*H. parviflora powder is prepared by the supplier from whole aerial parts of the plant (stems+thorns) according to the following procedure:

(i) aerial parts of H. parviflora plants of more than 3 years of age are excised and washed in tap water;

(ii) excised plant parts undergo sanitization with a disinfection agent;

(iii) sanitized plant parts are washed in tap water, dried (sun dried), and cut into pieces of 10-20 cm in size;

(iv) cut pieces undergo a second sanitization, washed and cut into cubes;

(v) cubes are frozen to (−18)° C.;

(vi) cubes are heated to 80° C. and then ground into a powder with particle size of about 600 micron. The powder is packaged and stored.

The plant parts are processed essentially immediately after their excision, such that the drying step is carried out within 24 hours from the harvest. The water content in the dry material following freezing and heating is up to 2.5%.

### Example 2

### Efficacy of the Sweetener Composition in Promoting Weight Reduction

The sweetener composition prepared in Example 1 is tested for its efficacy in promoting weight reduction in human subjects.

A first group of healthy subjects with BMI between 18.5-29.99 (corresponding to normal weight or overweight) is instructed to consume 8 grams of the sweetener composition of Example 1 (corresponding to 8 individual servings packaged in sachets) per day for 40 days. The participants are instructed to consume the sweetener composition by adding it into a beverage.

A second group of healthy subjects with the same BMI range is instructed to consume 8 grams of a sweetener composition which does not contain Hoodia (e.g., containing only rebaudioside A, 97% pure, and erythritol) per day for 40 days, by adding it into a beverage.

Other than that, the subjects in both groups are instructed to continue their regular dietary routine.

The weight of the subjects in both groups is measured at the beginning of the trial, following 3 weeks, and at the end of the 40 days.

### Example 3

### Efficacy of the Sweetener Composition in Promoting Weight Reduction—Comparative

One of the advantages of the sweetener composition of the present invention which combines Hoodia as a weight control agent is the ease of integrating it into the dietary routine. Thus, a sweetener composition according to the present invention is likely to be consumed more consistently compared to products such as dietary supplements comprising Hoodia as a weight control agent which are consumed separately, and consequently to provide a better outcome in terms of weight reduction.

A protocol was composed to demonstrate the efficacy of sweetener compositions prepared according to Example 1 in weight reduction in comparison to a dietary supplement containing ground Hoodia in a tablet form.

Two groups of healthy human subjects with BMI between 18.5-29.99 (corresponding to normal weight or overweight) are enrolled. One group receives a pack of 1 gram sachets containing a sweetener composition according to Example 1, and the other group receives a pack of tablets containing ground Hoodia (20 mg ground Hoodia per tablet). The first group is instructed to consume two sachets of the sweetener composition every day for three months. The second group is instructed to consume two tablets every day for three months at intervals of no less than 8-10 hours between tablets. The subjects in the first group are free to decide when to consume the sweetener product during the day. Other than that, the subjects in both groups are instructed to continue their regular dietary routine.

Subjects' reported compliance throughout the trial is evaluated and compared between the two groups. Subjects' weight is measured at the beginning and at the end of the trial and weight loss is compared between the two groups.

The foregoing description of the specific embodiments will so fully reveal the general nature of the invention that others can, by applying current knowledge, readily modify and/or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed chemical structures and functions may take a variety of alternative forms without departing from the invention.

1. A sweetener composition in a powder form comprising:
0.5%-2% (w/w) ground Hoodia,
1.5%-4.5% (w/w) rebaudioside A, wherein the rebaudioside A is at least 95% pure; and
95%-96.5% (w/w) erythritol.

2. The sweetener composition of claim 1, wherein the Hoodia is Hoodia parviflora.

3. The sweetener composition of claim 1, wherein the ground Hoodia is ground Hoodia prepared from whole aerial parts of the plant.

4. The sweetener composition of claim 1, wherein the rebaudioside A is at least 97% pure.

5. The sweetener composition of claim 1, consisting essentially of: 0.5%-2% (w/w) ground Hoodia., 1.5%-4.5% (w/w) rebaudioside A, wherein the rebaudioside A is at least 95% pure; and 95%-96.5% (w/w) erythritol.

6. The sweetener composition of claim 1, consisting essentially of: 0.5%-2% (w/w) ground Hoodia; 3% (w/w) rebaudioside A, wherein the rebaudioside A is at least 95% pure; and 95%-96.5% (w/w) erythritol.

7. The sweetener composition of claim 1, consisting of 2% (w/w) ground Hoodia, 3% (w/w) rebaudioside A and 95% (w/w) erythritol.

8. The sweetener composition of claim 1, consisting of 0.5% (w/w) ground Hoodia, 3% (w/w) rebaudioside A and 96.5% (w/w) erythritol.

9. The sweetener composition of claim 1, packaged as an individual serving of 1 gr. total weight.

10. A food product sweetened with the sweetener composition of claim 1.

11. An individual serving of a sweetener composition comprising ground Hoodia, which provides an amount of Hoodia that is no more than 5-10% of the amount generally recognized as safe for daily consumption, and further comprising rebaudioside A, wherein the rebaudioside A is at least 95% pure, and erythritol.

12. An individual serving of a sweetener composition consisting of: ground Hoodia, which provides an amount of Hoodia that is no more than 5-10% of the amount generally recognized as safe for daily consumption; rebaudioside A, wherein the rebaudioside A is at least 95% pure; and erythritol.
